(19) United States
(12) Patent Application Publication
(10) Pub. No.: US 2025/0278972 A1
(43) Pub. Date: Sep. 4, 2025

(54) CONTAINER RECOGNITION AND IDENTIFICATION SYSTEM AND METHOD

(71) Applicant: ASOFTA RECYCLING CORPORATION LTD., Yokneam Illit (IL)

(72) Inventors: Yaron BARDUGO, Yokneam Illit (IL); Liron PORAT, Hod HaSharon (IL)

(21) Appl. No.: 18/854,475

(22) PCT Filed: Apr. 4, 2023
(86) PCT No.: PCT/IL2023/050364

§ 371 Date: Oct. 4, 2024

Related U.S. Application Data
(60) Provisional application No. 63/327,565, filed on Apr. 5, 2022.

(51) Int. Cl. G07F 9/00; G06K 7/14; G06Q 10/30; G06V 10/774; G06V 10/82; G06V 20/50; G07F 7/06

(52) U.S. Cl. CPC G07F 9/006; G06K 7/1413; G06Q 10/30; G06V 10/774; G06V 10/82; G06V 20/50; G07F 7/06

(57) ABSTRACT

A system and method for using a reverse vending (RV) system configured to capture images. recognize the image and identify and record specific properties of containers deposited therein.

### FIELD OF THE INVENTION

The present invention generally relates to a containers' recognition and identification system and method and, more particularly, to a containers' identification system and method embedded in a reverse vending (RV) system configured to capture images, recognize the image and identify and record specific properties of containers deposited therein. Moreover, the present invention relates to an RV system that utilizes machine learning (ML) capabilities in order to recognize containers and identify properties thereof.

### BACKGROUND OF THE INVENTION

Reverse vending machines (RVMs) are configured to accept used and empty containers, for example, beverage containers, food packages, etc., and preferably, provide incentives in the form of coupons or some kind of return in order to encourage a user to recycle. RVMs are usually present in territories that have mandatory recycling laws or container deposit legislation. RVMs are considered a preferable solution to manual return systems which are labor intensive and suffer various systemic inefficiencies and deficiencies such as errors and corruption.

As most recycling schemes, the operations of RVMs may be funded by various sources. One such source may be the depositing method whereby vendors collect a mandatory payment upon sale of a product comprising a recyclable container while such mandatory payment is returned to a user upon the return of the container for recycling. Another source may originate from containers' manufactures who are lawfully obligated to off-set funds to be disbursed to users who returned recyclable containers. Some funding may include using excess on off-set funds for general environmental initiatives. Funding may be based on a combination of some such sources.

It is a common practice in various territories that enforce and maintain mandatory recycling laws or container deposit legislation, to establish and maintain a barcode identification database pertaining to the various containers sold in that certain territory. Such a barcode identification infrastructure may be used for various purposes, among them is the identification of particular containers and the attribution of specification characteristics regarding the container's recycling requirements and conditions as well as manufacturer's information which may be instrumental in effectuating the recycling funding.

In some cases, users may try to defraud the RVMs, and to get the deposit fee for illegal beverage container or for other illegal objects. In some cases, these fraud attempts involve the use of a legal bottle's barcode label, attached to an illegal object. In these cases, the machine detects the legal barcode, accepts the illegal object based on the identified barcode, and print a coupon for the deposit fee. In other cases, fraud attempts may involve an insertion of more than one object to the machine, while only one object is legal and the other is illegal. The machine detects the barcode of the legal object, but accepts both the legal and the illegal objects and hence compensate the user for two containers.

As more and more machines are deployed, these fraud attempts involve more and more losses. Moreover, it causes a mixture of materials, which then forms a significant barrier for materials recycling

Some RVMs, instruct a user to insert empty containers one by one into a receiving chute and some RVMs allow inserting a batch of empty containers at once. The containers may then be automatically sorted by various means in order to determine their classification (usually different kinds of plastic, metal or glass). For example, a beverage container may be scanned by an omnidirectional universal product code (UPC) scanner, which scans the beverage container's UPC which enables its classification. In another example, an RVM may consider a container's form, embossing, material or other identification parameters to try and match the container against an existing classification and identification database in addition to, or instead of, its barcode data.

Once a container is scanned, identified (using a database) and determined to be a recyclable participating container, it may be processed/crushed/shredded in a designated processor in accordance with its traits in order to reduce its size and hence, decrease its storage and transport volume and/or to avoid needless containment or spillage of liquid which may be contained within.

Prior art (such as US2020/0019947A1) discloses a surveillance camera data processing systems and methods for automatic detection cashier fraud by verifying images using artificial neural networks wherein an image of an item is received and saved with the data about a scanned product in the product database, then the abovementioned stages are repeated for each item placed against the barcode reader. Other prior art (such as U.S. Pat. No. 7,946,491B2) is known to disclose an apparatus for providing a camera barcode reader that includes a processing element configured to process an input image in order to decode the input image using a current barcode reading method, to determine whether the processing of the input image is successful, and to perform a switch to a different barcode reading method when faced with a failed attempt to decode the input image using the first barcode reading method. Also a scanner configured to verify barcodes is known in the prior art (such as U.S. Pat. No. 9,886,826B1), wherein the scanner has a processor and a memory for reading a barcode, capturing images of the product having the barcode, and generating notifications based on attributes of the barcode attached to the product. The processor measures barcode attributes specified by international barcode standards for each barcode extracted from the product images.

Although the field of barcode readers and image processing is widely discussed in prior art, it is not known as a method to detect and prevent frauds in RV system or method, based on machine learning algorithms, trained to detect objects which are not beverage containers and\or more than one beverage container, and based on a comparison between barcode detection and image processing.

Against said drawbacks and prior art there is a need to provide an RV system trained to identify objects which are not beverage containers and to prevent fraud attempts by using advanced machine deep learning algorithms. Moreover, there is a need to provide an RV system configured to capture, identify and record specific containers' parameters such as form, material, embossment etc., and to detect and prevent fraud attempts by comparing these captured parameters with the expected parameters of similar containers, based on their barcode.

### SUMMARY OF THE INVENTION

The following embodiments and aspects thereof are described and illustrated in conjunction with systems, devices and methods which are meant to be exemplary and illustrative and not limiting in scope. In various embodiments, one or more of the above-described problems have been reduced or eliminated, while other embodiments are directed to other advantages or improvements.

According to a first aspect of the invention, a method for using a reverse vending (RV) system comprising the steps of: (i) receiving containers to be recycled; (ii) retrieving available barcodes with a barcode scanning device; (iii) capturing at least one image of an unidentified container; (iv) sharing the captured image with a distributed database (DDB); and (v) identifying the unidentified container according to information received in steps (ii) and (iii), whereby steps (ii) and (iii) can be conducted in any order or in parallel, wherein the at least one image is designated to capture specific and unique parameters of a container to be identified, and wherein the DDB is shared by at least one more RV system, and wherein operation (ii)-(v) are controlled by a controller.

According to another aspect of the invention, the at least one captured image of an unidentified container is processed and analyzed by an ML model trained to identify unique and distinctive parameters of a container.

According to another aspect of the invention, the trained ML model is a DNN model trained to identify unique and distinctive parameters of an unidentified container. A deep neural network (DNN) provides a range of benefits desirous to the analysis of images in this application, crucially robustness to noise in image analysis, and adaptability for distributed databases, the former of which is necessary in order to maintain a high degree of accuracy in assessing unidentified containers which may range widely in appearance, and the latter of which is necessary in maintaining accurate analyses for multiple machines simultaneously accessing a distributed database.

According to another aspect of the invention, the training of the ML model is conducted by utilizing a training dataset configured to identify each type of container according to its at least one captured image.

According to another aspect of the invention, the ML model is configured to be trained by images of deformed/crushed containers. Containers requiring identification may not always arrive in perfect condition, especially given usage, storage, and transport practices of said containers, thus the ML model is required to identify containers that are partially or fully deformed, a functionality that can be provided by training the model with images of similarly deformed containers.

According to another aspect of the invention, the ML model is trained to identify whether the image or images of the unidentified container corresponds to a single object or to multiple objects. Some attempts at fraud in this field include the insertion of multiple objects, which is deleterious to downstream recycling processes.

According to another aspect of the invention, the ML model is trained to identify whether the image or images of the unidentified container corresponds to the container in the DDB associated with the scanned barcode.

According to another aspect of the invention, multiple containers are received as a bundle by the RV system. Whilst some attempted fraud pertains to the insertion of multiple container masquerading as a single container, the volume of containers requiring insertion exceeds the capacity of users to insert each container individually, thus the system is configured to receive bundles of containers.

According to another aspect of the invention, each container is individually received by the RV system. For many users, only a single container is required for insertion, such as a single use container purchased locally and used immediately.

According to another aspect of the invention, once a container has been identified, it is processed in a designated processor in order to reduce its volume, as part of a recycling process. Such removal processes may involve crushing, shredding, pulverizing, grinding, squashing, or otherwise processing into a smaller volume.

According to another aspect of the invention, barcode scanning includes also QR code scanning. Containers may include barcodes or QR codes, both of which are capable of carrying important information corresponding to items in the DDB.

According to another aspect of the invention, the identification of unidentified containers is conducted according solely to the image captured. In many cases, the bar code is either unavailable due to damage of the container or was never available on the container in question, however the unidentified container can still be identified with the methods and systems taught in this disclosure.

According to another aspect of the invention, a reverse vending (RV) system comprising: a barcode scanning device; and an image capturing device configured to obtain at least one image of a deposited container's specific and unique parameters; and a controller, wherein the controller is in communication with the barcode scanning device and image capturing device components and with a DDB. A controller may be a any computer device, with components including at least one processor, a memory device, and an interface, and may be application programmable.

According to another aspect of the invention, the barcode scanning device and the image capturing device are the same device. In cases where the container is identifiable by a QR code rather than a conventional linear UPC barcode, the image capturing device is capable of capturing the requisite image of the QR code for identification therewith. The system taught herein can also be configured to other forms of bar code identification, including conventional linear UPC bar codes, with an image capturing device such as a camera.

According to another aspect of the invention, the controller is configured to execute at least one ML model trained to identify unique and distinctive parameters of a container.

According to another aspect of the invention, the ML model executed by the controller is a DNN model trained to identify unique and distinctive parameters of an unidentified container.

According to another aspect of the invention, the DDB is shared by at least one more RV system. By operating multiple RV systems together which share a DDB, operators are afforded several advantages in managing both the said RV systems and the DDB,

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention.

In the Figures:

FIG. 1 constitutes an operation flow chart describing certain possible operations of an RV system or method, according to some embodiments of the invention.

FIG. 2 constitutes a schematic perspective view of an RV system, according to some embodiments of the invention.

FIG. 3a constitutes schematic illustrations of the detection apparatus, according to some embodiments.

FIG. 3b constitutes schematic illustrations of the conveyor system of a RV system, according to some embodiments.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “controlling” “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, a cloud computing system or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Unless explicitly stated, the method embodiments described herein are not constrained to a particular order or sequence. Additionally, some of the described method embodiments or elements thereof can occur or be performed simultaneously, at the same point in time, or concurrently.

The term “Controller”, as used herein, refers to any type of computing platform or component that may be provisioned with a Central Processing Unit (CPU) or microprocessors, and may be provisioned with several input/output (I/O) ports, for example, a general-purpose computer such as a personal computer, laptop, tablet, mobile cellular phone, controller chip, SoC or a cloud computing system.

The term “Machine Learning” or “ML”, as used herein, refers to the study of computer algorithms that can improve autonomously through experience and by the use of data. Machine Learning algorithms contribute to the evolvement of a model based on sample data, known as “training data”, in order to make predictions or decisions without being explicitly programmed to do so.

The term “Deep Neural Network” or “DNN”, as used herein, refers to a computer model that include connectionist systems that are inspired by, but not identical to, biological neural networks that constitute animal brains. A deep neural network can consist of multiple layers. The data elements which are the output of a given layer are typically the input of the following layer (though sometimes the output of given layer can also be used as an input of a deeper layer which is not the following one). A “Deep” neural network is a neural network which has at least one “hidden” layer. A hidden layer is a layer that has two properties: Its input is not the input of the system (but the output of other layer(s)); Its output is not the output of the system (but is used as an input to other layer(s)). The properties of a hidden layer typically mean the designer of the system does not know what the hidden layer represents in the calculation and “blindly trusts” the training process to “imbue something useful” into the layer.

The term “Convolutional Neural Network” or “CNN”, as used herein, refers to a DNN that has at least some convolutional layers. Each specific neuron in a convolutional layer does not use all the data elements in the input of the layer but only the data elements which are “closer” to it. All the neurons in the convolutional layer use an identical set of weights (cooperatively trained) while a given neuron multiplies a given data element by a weight which is a function of the “distance” between the data element and the neuron.

The term “Distributed Database system” or “DDB” as used herein, refers to an integrated collection of databases that is physically distributed across sites in a computer network and comprises a common interface to access distributed data. A distributed database management system (DDBMS) is the software system that manages a distributed database such that the distribution aspects are transparent to users. A DDB may be stored in multiple computers located in the same physical location (e.g., a data center) or maybe dispersed over a network of interconnected computers (e.g. a cloud computing platform).

The present invention discloses a reverse vending (RV) system and method configured to identify specific parameters of particular containers being loaded into the RV system by comparing the image of each container to an existing database, and, in case a container is not included in said database, the RV system is configured to capture image(s) of the unidentified container and send said image to a barcode database distribution system (DDB).

According to some embodiments, the RV system is configured to monitor, detect and capture images of deformed/damaged/crushed containers that cannot be identified using a barcode reader, and associate such containers with a DDBMS which, in turn, will allow acceptance of such containers by other RV systems on basis of said association. According to some embodiments, once the system accumulates a large number of captured images of containers per a given timeframe, such images may be used in an ML training model for the purpose of providing identification capabilities of unrecognizable types of containers according to their image (instead of other identification means, such as a barcode), despite them being substantially deformed.

According to some embodiments, the RV system is configured to monitor, detect and capture images of deformed/damaged/corrupt barcodes placed on containers that cannot be directly read or identified using conventional barcode readers and associate such containers with a DDBMS which, in turn, will allow acceptance of such containers by other RV systems. According to some embodiments, once the system accumulates a large number of captured images of deformed/damaged/corrupt barcodes per a given timeframe, such images may be used in an ML training model for the purpose of providing identification capabilities of unrecognizable types of containers according to their image (instead of other identification means, such as a common barcode or QRCode), despite them being substantially deformed.

According to some embodiments, a controller may be adapted to control the RV system, for example, a programmable logic controller (PLC) may be adapted to control the motion of various components forming the RV system. Said controller may be configured for processing, storing and retrieving data from various sensors monitoring the operation of the RV system. According to some embodiments, a software program may also control the operation of the RV system and display messages or other feedback to the user on a designated output means such as a screen.

According to some embodiments, several types of sensors may provide data to a controller (that may be a personal computer (PC), PLC, cloud computing platform, etc.) that controls various operations of the RV system. For example, should a container fail to completely pass the intake chute, the RV system may be disabled and a warning message or indication displayed to the user.

According to some embodiments, an RV system or method may be comprised of the following components/steps:
a. An image scanning device such as a barcode reader configured to read a containers' barcodes automatically. According to some embodiments, the barcode reader may be a pen type barcode reader that consist of a light source and photodiode that are placed next to each other in the tip of a pen like structure. To read a barcode, the pen-like structure embedded within the RV system must move across the barcode of a container at a relatively uniform speed.

According to some embodiments, the barcode reader may be a laser scanner configured operate in a similar manner as the pen-type reader disclosed above, except that a laser scanner uses a laser beam as a light source and typically employs either a reciprocating mirror or a rotating prism to scan the laser beam back and forth across the barcode.

According to some embodiments, the barcode reader may be a Charge Coupled Device (CCD) reader that uses an array of minute light sensors lined up in a row in the head of the reader. Each sensor is configured to measure the intensity of the light immediately in front of it. Each individual light sensor in the CCD reader is extremely small and because there are hundreds of sensors lined up in a row, a voltage pattern identical to the pattern in a barcode is generated in the reader by sequentially measuring the voltages across each sensor in the row.

According to some embodiments, the barcode reader may be a camera-based reader having two-dimensional imaging scanners. that uses a camera and image processing techniques to decode the barcode. Usually, video camera readers use small video cameras with the same CCD technology as in a CCD barcode reader except that instead of having a single row of sensors, a video camera has hundreds of rows of sensors arranged in a two-dimensional array so that they can generate an image that, in turn, identifies the barcode.

According to some embodiments, the barcode reader may be a laser based omnidirectional barcode scanners that uses a series of straight or curved scanning lines of varying directions. Unlike the simpler single-line laser scanners, omnidirectional barcode scanners produce a pattern of beams in varying orientations allowing them to read barcodes presented to it at different angles. Omnidirectional barcode scanners may use a single rotating polygonal mirror and an arrangement of several fixed mirrors to generate their complex scan patterns.
b. An image capturing device such as a camera configured to retrieve the image of unrecognized containers and record image/s.
c. An ML model configured to utilizes ML technology in order to detect certain parameters such as patterns/shapes/forms that form a part or an area/volume of a container of interest. According to some embodiments, an ML model configured to be utilized as part of the container's identification procedure may be a DNN model such as a CNN model commonly applied to analyze visual imagery.

According to some embodiments, and as previously disclosed, the RV system may be configured to use ML technology in order to replace barcode readers or mitigate their limitations. For example, the RV system may capture several images (e.g., ˜10 images) of each container inserted into the RV system.

According to some embodiments, these images may be taken from different angles. According to some embodiments, only images of defected/crushed containers or containers having defective barcodes may be captured. According to some embodiments, once the RV system accumulates a large number of captured images of containers per day (e.g., ˜500 images), the captured images may be used to train an ML model by utilizing a training dataset for the identification of each type of container according to its captured image/s no matter how crushed and/or deformed it may be. According to some embodiments, such an ML based process may replace the use of barcode readers or any other traditional technologies currently being used by known RVMs.

According to some embodiments, after the application of the ML model, the data gathered by the RV system, that may include multiple images of a container of interest, may be sent to a designated repository database. According to some embodiments, said repository database may be autonomously or manually monitored. In case of manual monitoring, a human may be in charge of deciding whether a certain container should be added to the distributed database. In case of an autonomous monitoring, a decision whether a container should be added to the distributed database may be conducted by a controller. According to some embodiments, various RV systems that share the same repository database, may receive constant updates and therefore be able to process newly added containers' types.

According to some embodiments, the RV system may prevent fraud by detecting unrecyclable containers that may be intentionally inserted into the RV system in manners designed to receive the recycling incentive disbursement, such as by insertion of objects fashioned to misrepresent resemblance to barcoded recyclable containers

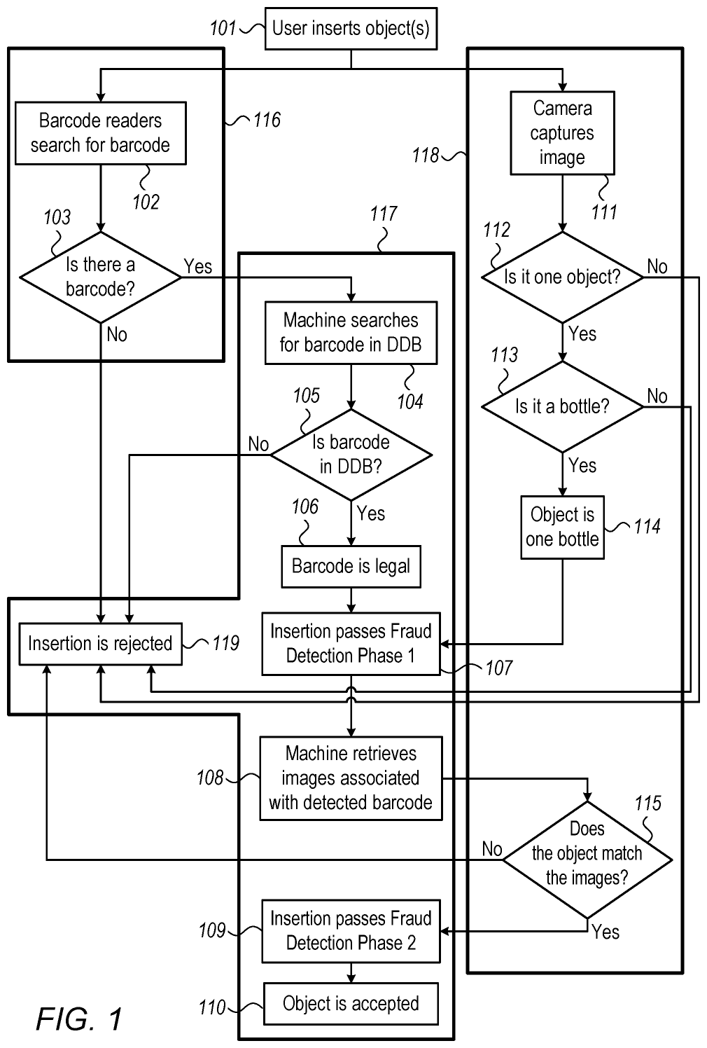

Reference is now made to FIG. 1 which illustrates an operation flow chart describing certain possible operations designated to control the RV system. Two phases of fraud detection determine if the inserted item is legal for the RV system

The first phase of fraud detection is conducted thus: In operation 101, the user inserts the item(s) requiring identification, at this point two parallel methods of assessment are carried out simultaneously, the first commencing with operation 102 and the second with operation 111. In operation 102 the bar code scanning devices search for a bar code on the item(s), and then the analysis determines in decision point 103 if a bar code is present. If the result of decision point 103 is positive, the analysis moves to operation 104, wherein the system searches for the scanned barcode in the DDB, and then determines in decision point 105 if the scanned barcode is saved therein. If the result of decision point 105 is positive, the analysis moves to operation 106, wherein the machine declares that the barcode is legal.

In parallel to the operations and decision point 102-106, a separate method of analysis is conducted, commencing with operation 111, wherein a camera captures an image, and then the analyses determines in decision point 112 if the captured image represents just one item. If the result of decision point 112 is positive, the analysis moves to decision point 113, which determines if the captured image represents a bottle or other container. If the result of decision point 113 is positive, the analysis moves to operation 114, wherein the analysis declares that the object represented in the captured image is a single bottle or other container.

The method is then capable of combining parallel analyses conducted in operations and decision point 102-106 and operations and decision points 111-114, such that if both operations 106 and 114 are conducted, then the analysis is permitted to move to operation 107, wherein the inserted item is declared to have passed the first fraud detection phase. In systems and applications not requiring a barcode, the operation 107 does not require that the operation 106 is conducted.

The second phase of fraud detection is conducted thus: in operation 108 the system retrieves images associated with the scanned barcode from a DDB. The analysis then moves to decision point 115, which determines if the captured image matches the retrieved images from the DDB. If the result of decision point 115 is positive, the analysis moves to operation 109, wherein the inserted item is declared as having passed the second fraud detection phase, and the analysis moves to operation 110, wherein the item is accepted.

If the result of any of the decision points in FIG. 1 is negative, the analysis arrives at operation 119, wherein the inserted item(s) is rejected.

According to some embodiments, the systems which conduct the analysis outlined in FIG. 1 are: a barcode scanning system 116 that operates operation and decision point 102 and 103; a computer device in communication with a DDB 117 that operates operations and decision points 104-110 and 119; and a ML system in communication with a camera device that operates operations and decision points 111-115.

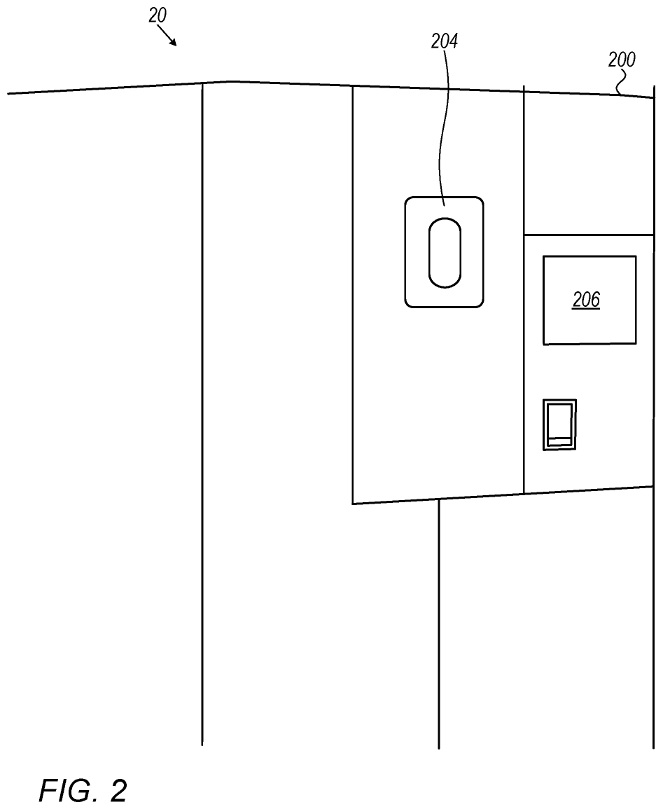

Reference is now made to FIG. 2 which schematically illustrates an RV system 20, according to some embodiments. As shown, the RV system 20 includes an interface compartment 200. The interface compartment 200 comprises a previously disclosed intake chute 204 designated to allow a user to load a variety of containers into RV system 20. According to some embodiments, interface compartment 200 may have a contemporary design configured to distinctively stand out and allure user to recycle, for example, intake chute 204 may be adorned by a LED light which will notify the user about the status of the RV system 20, etc.

According to some embodiments, screen 206 is configured to be mounted upon and provide instructions and feedback to a user of the RV system 20, for example, screen 206 may be an immersive touch screen tilted toward the user or any other screen type configured to clearly display data to a user. According to some embodiments, screen 206 may be implemented with a user-friendly touch screen which lets the user to access and modify information on his fingertips, wherein the UI interface is keeping a minimalistic display for easy and quick operation. According to some embodiments, screen 206 provides user with information of identified container and the relevant disbursement thereto, whereby such screen is in communication with controller 206 and/or DDB 208.

According to some embodiments, RV system 20 enables user to deposit container in a continuous uninterrupted operation regardless of the type of container, its material and/or order of their deposit into the RV system 20.

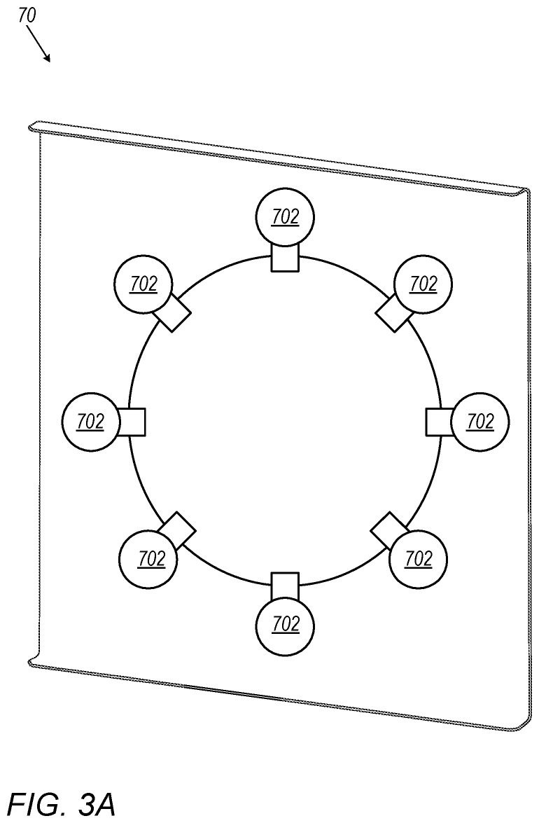

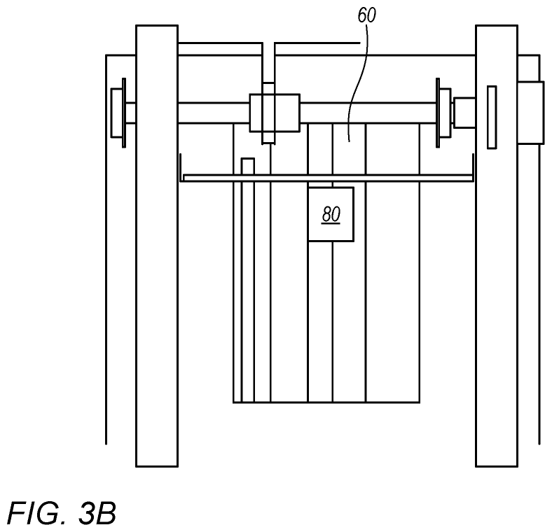

Reference is now made to FIG. 3A which schematically illustrates detection apparatus 70 of a RV system 20, which may facilitate operation 102/111, according to some embodiments. As shown, detection apparatus 70 is configured to be in close proximity to intake chute 204 such that a container inserted into the RV system 20 will be identifiable from every angle. According to some embodiments, multiple image capturing devices 702 are arranged on circumference of frame 704 in order to enable capturing a substantially 360 degrees view of every container inserted by the user. According to some embodiments, detection apparatus 70 is configured to be placed at the inner circumference of the insert chute 204 in order to provide fast detection capabilities. According to some embodiments, each image capturing device 702 may be a camera capable of capturing images to be later identified and analyzed by a controller. According to some embodiments, an image capturing device 70 may be a barcode reader capable of reading the barcode of each container and sort it accordingly.

According to some embodiments, multiple image capturing devices 702 may partially be cameras while others be designated UPC barcode readers.

Reference is now made to FIG. 3B which schematically illustrates an upper view of conveyor system 60 and an image capturing device 80 forming a part of RV system 30, according to some embodiments. As shown, image capturing device 80 may be configured to be mounted above conveyor 60 in order to have a clear view of containers being sorted and/or conveyed. According to some embodiments, image capturing device 80 may be a camera capable of capturing images to be later identified and analyzed by the controller. According to some embodiments, image capturing device 80 may be a barcode reader capable of reading the barcode of each container and sort it accordingly. According to some embodiments, several capturing devices such as image capturing device 80 of different types (camera, CCD, UV, RF, UPC reader, etc.) can be included in RV system to control the process.

According to some embodiments, the controller may be adapted to control the various operations of the image capturing devices 70/80 by, for example, process, store and retrieve data from the image capturing devices 70/80 in order to detect and process gathered data regarding a containers' features and parameters, and hence providing accurate detection abilities allowing to properly sort a particular container to a designated processor and receptacle.

According to some embodiments, the processed materials produced by the RV system that have been collected or sent to recycling facilities may provide raw materials available for various industries.

Although the present invention has been described with reference to specific embodiments, this description is not meant to be construed in a limited sense. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

1. A method for using a reverse vending (RV) system comprising the steps of:
(i) receiving containers to be recycled,
(ii) retrieving available barcodes with a barcode scanning device,
(iii) capturing at least one image of an unidentified container,
(iv) sharing the captured image with a distributed database (DDB), and
(v) identifying the unidentified container according to information received in steps (ii) and (iii),
whereby steps (ii) and (iii) can be conducted in any order or in parallel, wherein the at least one image is designated to capture specific and unique parameters of a container to be identified, and
wherein the DDB is shared by at least one more RV system, and
wherein operation (ii)-(v) are controlled by a controller.

2. The method of claim 1, wherein the at least one captured image of an unidentified container is processed and analyzed by an ML model installed on a controller trained to identify unique and distinctive parameters of a container.

3. The method of claim 2, wherein the trained ML model is a DNN model trained to identify unique and distinctive parameters of an unidentified container.

4. The method of claim 2, wherein the training of the ML model is conducted by utilizing a training dataset configured to identify each type of container according to its at least one captured image.

5. The method of claim 2, wherein the ML model is configured to be trained by images of deformed/crushed containers.

6. The method of claim 2, wherein the ML model is trained to identify whether the image or images of the unidentified container corresponds to a single object or to multiple objects.

7. The method of claim 2, wherein the ML model is trained to identify whether the at least one image of the unidentified container corresponds to the container in the DDB associated with the scanned barcode.

8. The method of claim 1, wherein multiple containers are received as a bundle by the RV system.

9. The method of claim 1, wherein each container is individually received by the RV system.

10. The method of claim 1, wherein once a container has been identified, it is processed in a designated processor in order to reduce its volume, as part of a recycling process.

11. The method of claim 1, wherein barcode scanning includes also QRcode scanning.

12. The method of claim 1, wherein the identification of unidentified containers is conducted according solely to the image captured.

13. A reverse vending (RV) system comprising:
(i) a barcode scanning device; and
(ii) an image capturing device configured to obtain at least one image of a deposited container's specific and unique parameters, and
(iii) a controller,
wherein the controller is in communication with the barcode scanning device and image capturing device components and with a DDB

14. The system of claim 13 wherein the barcode scanning device and the image capturing device are the same device.

15. The system of claim 13, wherein the controller is configured to execute at least one ML model trained to identify unique and distinctive parameters of a container.

16. The system of claim 15, wherein the ML model executed by the controller is a DNN model trained to identify unique and distinctive parameters of an unidentified container.

17. The RV system of claim 13, wherein the DDB is shared by at least one more RV system.
